(19) United States
(12) Patent Application Publication
(10) Pub. No.: US 2012/0143594 A1
(43) Pub. Date: Jun. 7, 2012

(54) Enhanced operator-precedence parser for natural language processing

(76) Inventor: Gregory John McClement, Maple Ridge (CA)

(21) Appl. No.: 12/959,308

(22) Filed: Dec. 2, 2010

(51) Int. Cl. G06F 17/20

(52) U.S. Cl. 704/8

(57) ABSTRACT

An operator-precedence parser is disclosed that incorporates enhancements that support analysis of human languages. Operator-precedence parser are typically used to analyze arithmetic expression in calculators. Enhancements include allowing the result of applying an operator to be another operator; allowing elements to have a priority as an operator and a priority as an operand; allowing operands to have their priority determined by context; allowing a series of priorities to be specified for operators. These series of enhancements enable analysis of sentences that are more complex than can typically be handled by declaration based parsers. For example, the utterance “move tank1 and tank2 to position1 move tank2 to position1 fire tank2 at tank1 fire tank3 at tank1 6*6” can be successfully analyzed by a working system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

The listing main.txt created on Dec. 1, 2010 with size 54,654 bytes contains an implementation of an enhanced operator precedence parser. The implementation language is Prolog. ‘matrix_next’ contains the top level function implementing the algorithm. ‘matrix_select_operators’ selects the operator to apply. ‘matrix_apply_operator_one’ applies the selected operator. ‘selector’ is used to select the arguments. \matrix_apply_evaluator’ applies the selected operator to the selected arguments.

### BRIEF SUMMARY OF THE INVENTION

An operator-precedence parser is disclosed which incorporates enhancements that facilitate analysis of human languages. In extant models for operator precedence parsing (such as the Shunting Yard algorithm) an operator is assigned a priority number. That number determines how the parser will build the structure of the expression. The parser applies the operators in order of precedence. Once an operator is applied the result is terminal symbol. Operators are applied highest priority first until a final since value is produced. This is typically used for analyzing arithmetic expressions. Enhancements advanced extent this approach to handle unrestricted natural languages. Enhancements include allowing the result of applying an operator to be another operator; allowing elements to have a priority as an operator and a priority as an operand; allowing operands to have their priority determined by context; allowing a series of priority to be specified for operators. These series of enhancements enabled analysis of sentences that are more complex than can typically be handled by declaration based parsers.

### BACKGROUND OF THE INVENTION

This invention disclosed herein relates to creation of structure data from plain text and more particularly to a processor that creates structured data from plain test using an enhanced operator precedent parser.

There is a strong desire arising to provide every person access to the power of computers. This requires that computer systems that are able to interact using languages natural to users. Typical approaches to analyzing the structure of languages use declarative grammar based-approaches that fail to address complex linguistic structures that are commonly presented.

Time has shown that declarative grammar based approaches such as unification grammars are not easily extended to effectively handle common problem such as conjunction, incompleteness and multiple languages. This is the case although a large number of resource have been applied to the declarative grammar approach.

Early in the development of computer science an alternative approach for analyzing expression structure was defined. This is operator precedence parsing. These types of parsers are typically used to convert expressions in infix notation into reverse polish notation for evaluation as used in hand calculators. A well known implementation using the Shunting Yard algorithm developed by Edsger Dijkstra.

The configuration of an operator precedence parser contains associations between operators and control parameters. A control parameter is a 3-tuple comprising a numeric priority, an argument type and semantics for applying the operator. The argument type specifies how the operator selects its arguments. For example, the ‘+’ operator selects one argument from the left side and one argument from the right side of the operator in the expression; the unary ‘−’ operator selects one argument from the right side of the operator in the expression. The semantic for applying the operator is the definition of how to calculate the result of applying the operator to the arguments.

What follows is a worked example for the operator precedence parser. The table in FIG. 1 also known as a lexicon defines the operators. In this case xfx means an operator that takes two arguments one from the left and one from the right side. fx means a unary operator that takes one argument from the left. This notation is a standard available in a well known computer language called Prolog. Number are represented symbolically in the tables using the “<numbers>” entry.

The simplest algorithm for implementing an operator precedence parser would be

1. Lookup each token in the lexicon and augment them with the control definition in order to create the list of elements. This is called Es.

2. For each token lookup up the control in the lexicon.

3. While there is more that one element in the list, Es
A. Find the left-most operator with the highest priority. This is called O. If there is no O then proceed to step 4.
B. Using the type, select the arguments, called As.
C. Apply the evaluator to the arguments and replace O and As in the list Es with the result that has priority zero, type of number and no selector or evaluator.

4. Emit the list Es as the result

What follows is a worked example for the input “6+5*−2” assuming steps one and two have been performed. FIG. 2A shows the initial state of the calculation.

FIG. 2B show the result of applying one iteration of the algorithm.
A. Element A5 is selected as the operator since the priority is the highest
B. Element A6 is selected as the argument.
C. Elements A5 and A6 are replace by the result at position B5.

FIG. 2C shows the result of the next iteration of the algorithm.
A. Element B4 is selected as the operator since the priority is the highest
B. Element B3 and B5 are selected as the arguments.
C. Elements B3, B4 and B5 are replaced by the result at position C3.

FIG. 2E shows the result of the final iteration of the algorithm.
A. Element C2 is selected as the operator since the priority is the highest
B. Element C1 and C3 are selected as the arguments.
C. Elements C1, C2 and C3 are replaced by the result at position D1.

The calculation is now complete.

This example illustrates the main control structure which comprises a priority for determining when to apply an operator, a type for determining what the apply the operator to and a semantic for calculating the result of applying the operator. What follows is an invention that extends the features of the operator precedence parser to be able to handle constructs that arise in natural languages used by humans.

### BRIEF DESCRIPTION OF THE SEVERAL VIEWS OF THE DRAWINGS

FIG. 1 shows operator definitions for a simple operator precedence parser

FIG. 2A shows input for sample parse

FIG. 2B-D shows example parse matrix steps

FIG. 3 shows selector definition for a natural language parser

FIG. 4 shows evaluator definitions for a natural language parser

FIG. 5 shows selector definitions for a natural language parser

FIG. 6 shows constructor definitions for a natural language parser

FIG. 7 shows old operator definitions using the new model

FIG. 8A shows lexicon definition for example one

FIG. 8B shows input for example one

FIG. 8C-L shows example one parse matrix steps

FIG. 9A shows the lexicon for tokenization example FIG. 9B-C shows example parse matrix steps

FIG. 10 shows definitions for common English work/phrase types

### DETAILED DESCRIPTION OF THE INVENTION

The basic operator precedence parser specifies a priority and semantic for each operator. The priority is a number that is used to determine the order that operators are applied. The semantic is an method that provides the steps to perform a calculation on the arguments. In the enhanced operator precedence parser presented here the priority and semantic specification are extended. This is know as the control definition. The control is a list of single control definitions.

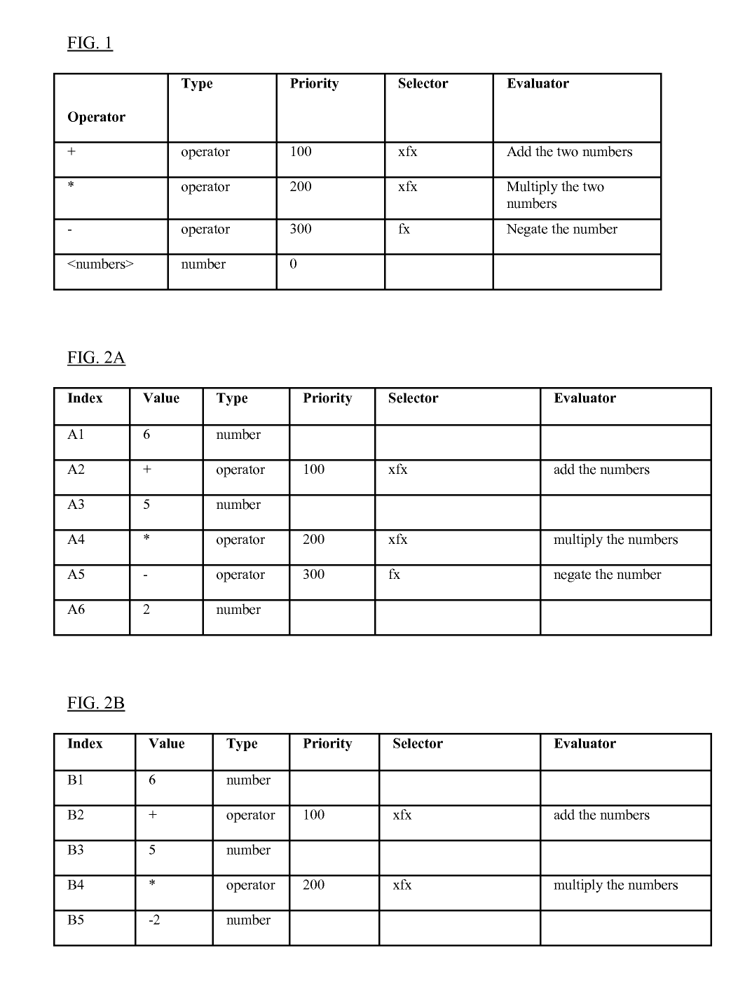

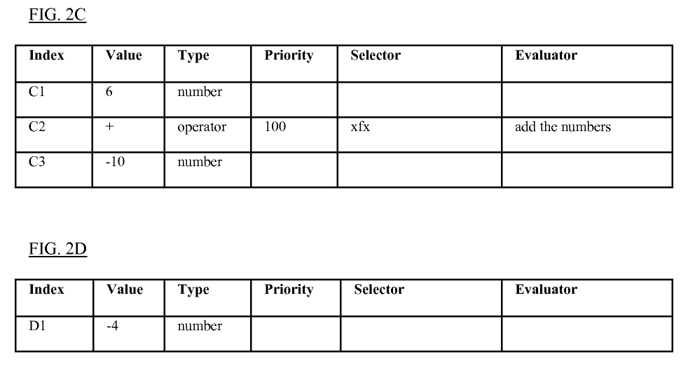

This invention extends the control definition for operators as follows. For reference to the simple control definitions see FIG. 1.

The priority is extended from being a single number to a pair. There is one priority for the element as an operator and one priority for the element as an operand. When selecting the highest priority operator, the operator priority is used. When being selected as an operand for another operator, the priority of the element as an operand is used. A subsequent example will demonstrate verbs and adverbs being defined as operators. An adverb will take a verb as an operand and will evaluate to a verb type operator. When the priority as an operator and an operand are the same only one number will be show in the table.

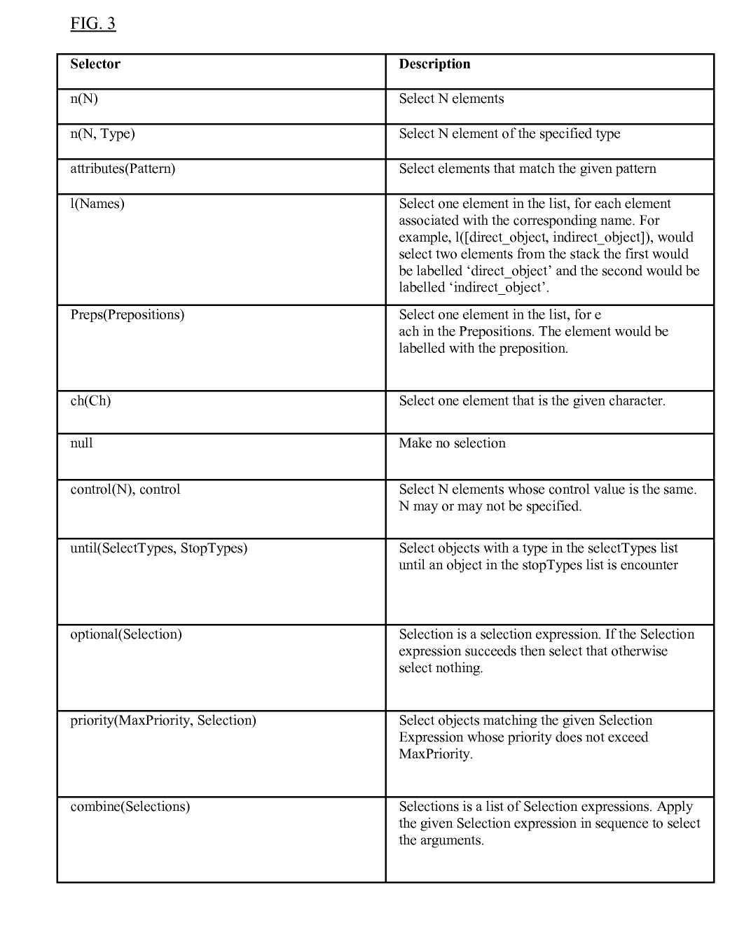

The type is extended to provide operators for selecting arguments from the matrix containing the current set of elements. The type is a pair of selection operators. One for selection from the left of the operator and one for selection from the right of the operator. The selection commands are defined in FIG. 3.

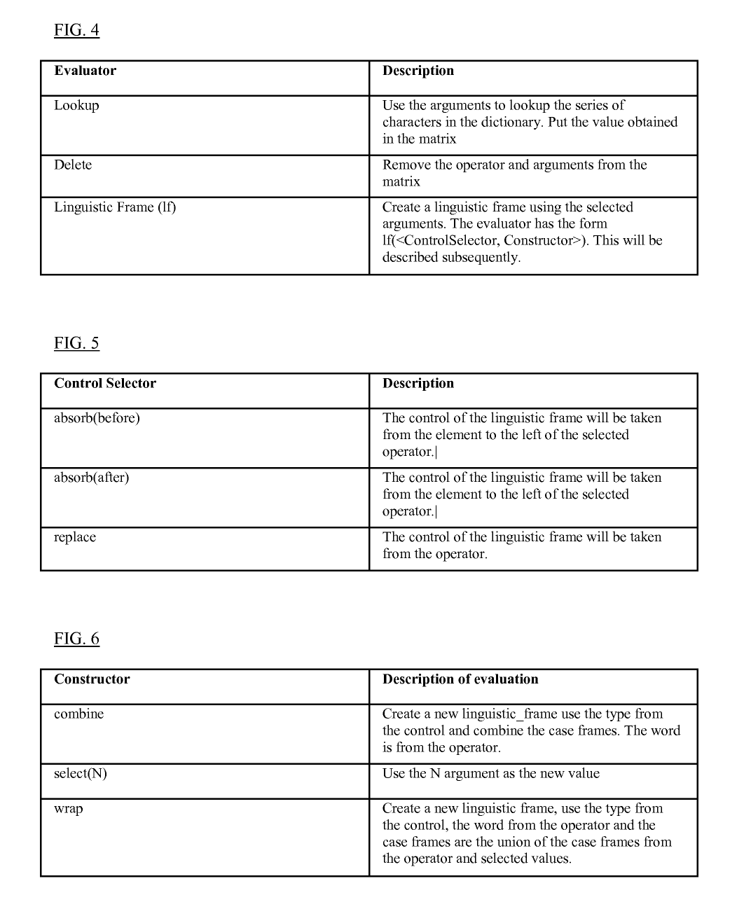

After the operator is applied based on the priority and the arguments are selected using the selectors, the evaluator is used to calculate the value of applying the operator the arguments. FIG. 4. shows evaluator definitions.

The matrix that the processing is performed in can contain any type of element as long as the semantics can process them. One such type is the linguistic frame. This will be shown for illustrative purposes. Examples of elements that could be in the matrix are phonemes, characters, words, function calls. Although the examples demonstrate parsing and tokenization, other stages of analysis can be performed in this model as well.

For extant implementations the linguistic frame is used to represent the structure of the utterance. The linguistic_frame has the form linguistic_frame(Type, Word, Cases). Cases a list that associates a case name with a value. A sample linguistic_frame would be

linguistic_frame(verb, is, [subject-(the sky), direct_object-blue]).

This would correspond to a sentence such as “The sky is blue”.

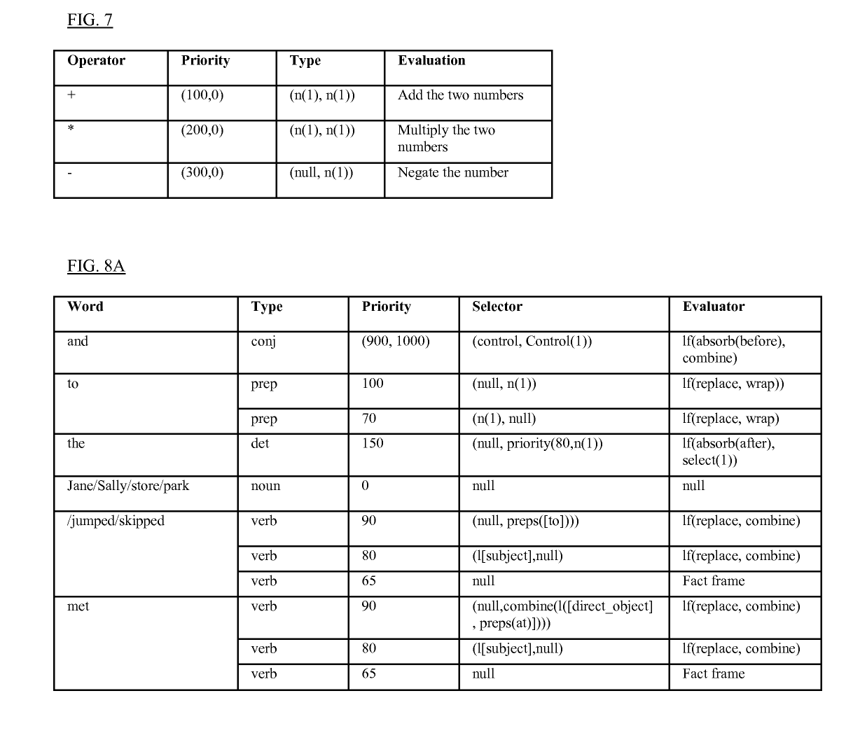

FIG. 5 shows the table that describes the control selector parameters for the linguistic frame evaluator. FIG. 6 shows the table that describes the constructor parameter for the linguistic frame evaluator. For each element, the control is an ordered list of 3-tuple comprising (Priority, Selector, Evaluator) using the enhanced definition for these components. The table of the simple operator precedence parser example can be updated under the new model as seen in FIG. 7.

The final piece is to update the algorithm converting the input into a value. The generalized method is as follows.

Input: A sequence of characters.

Output: A sequence of elements

Method:

1. Lookup each token in the lexicon and augment them with the control definition in order to create the matrix of elements. This is called Es.

2. Set a list of operators to empty. This is called O.

3. Find the element in Es with the highest operator priority not in O. This is called E.
A. If no such element exists then proceed to step 4.
B. Add the element E to the set O.
C. Use the selection expression to select the elements from the matrix. These are the arguments that are called A.
D. If the selection fails proceed to step 3.
E. Apply the evaluator to the arguments A to yield the result R.
F. Replace the selected element E and the arguments A with the result R in the list of elements Es.
G. Proceed to Step 2.

4. Find the element with the highest operator priority

5. If such an element exists remove the first control definition and replace it in the list Es. Proceed to step 2.

6. Emit the current sequence as the output.

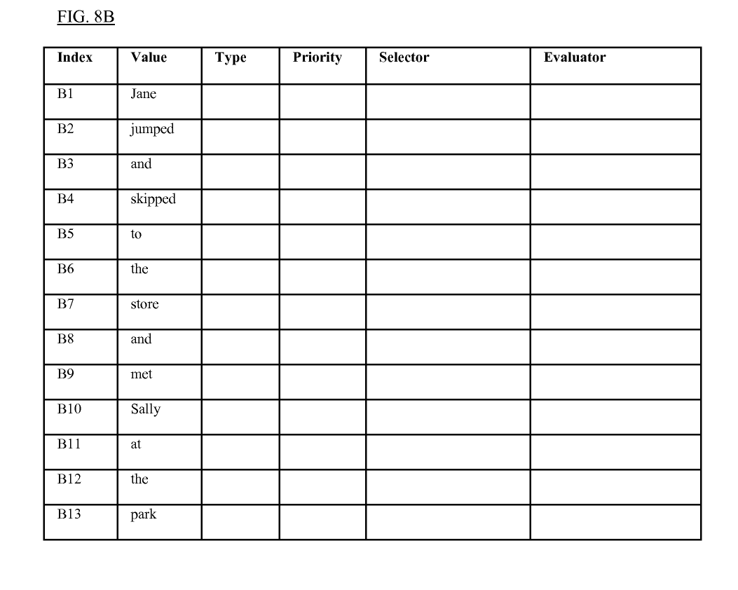

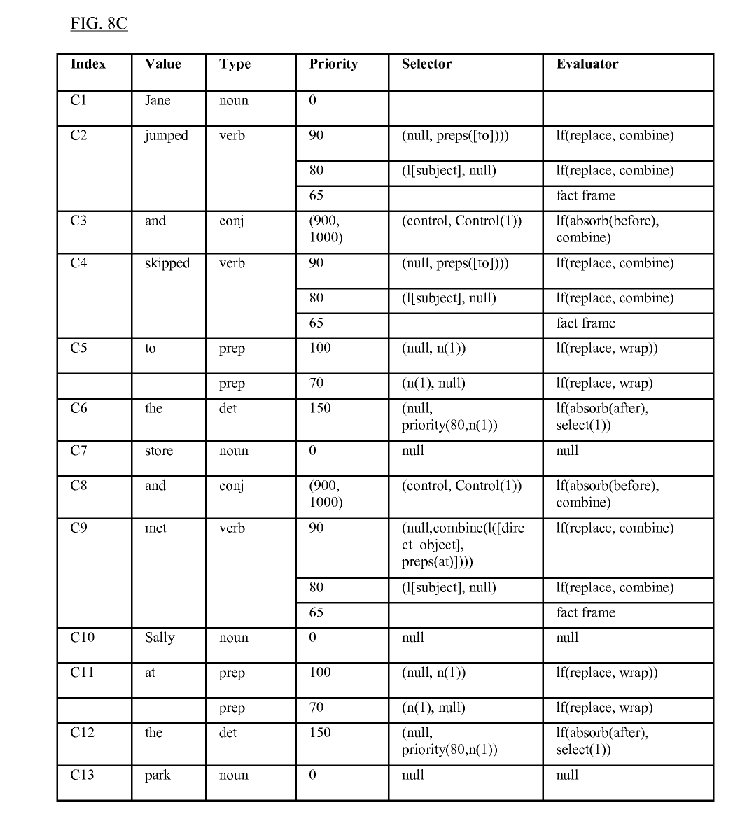

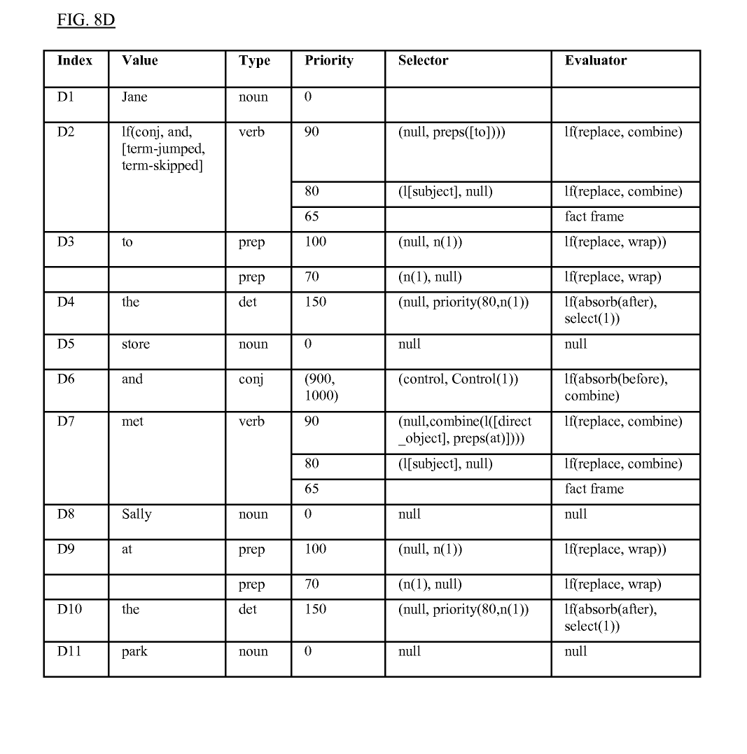

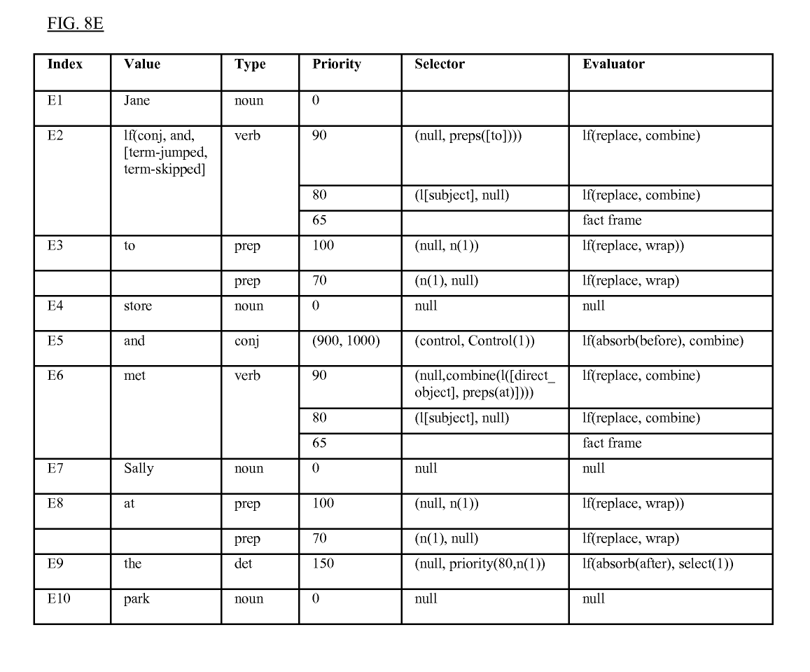

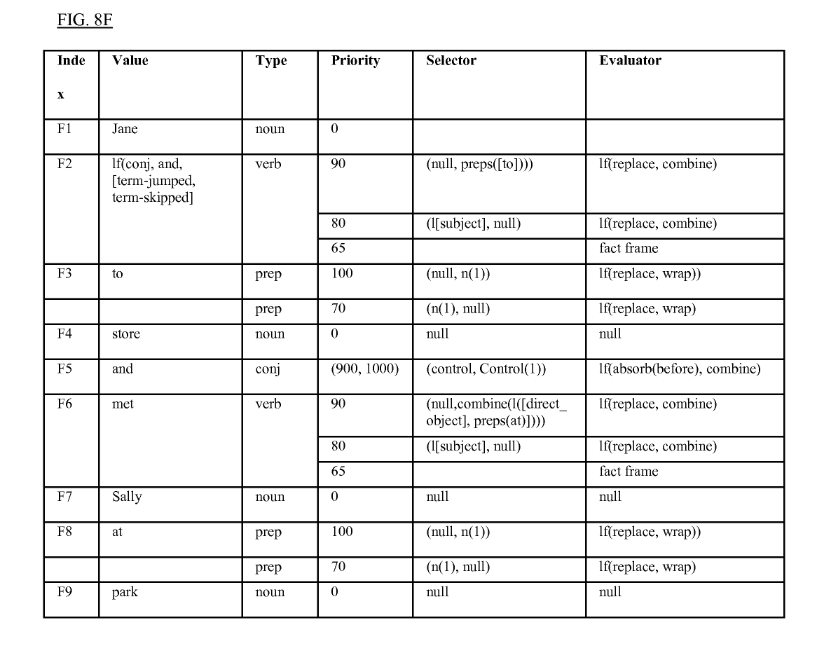

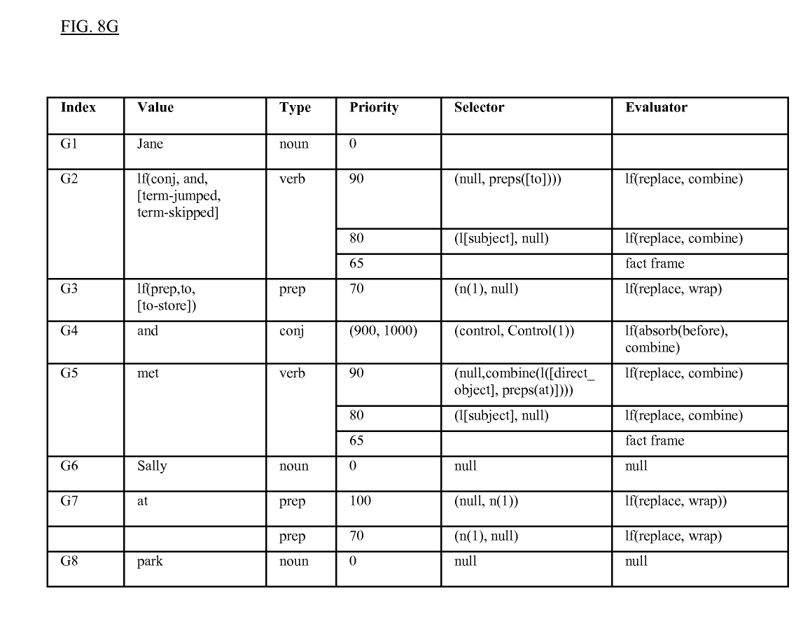

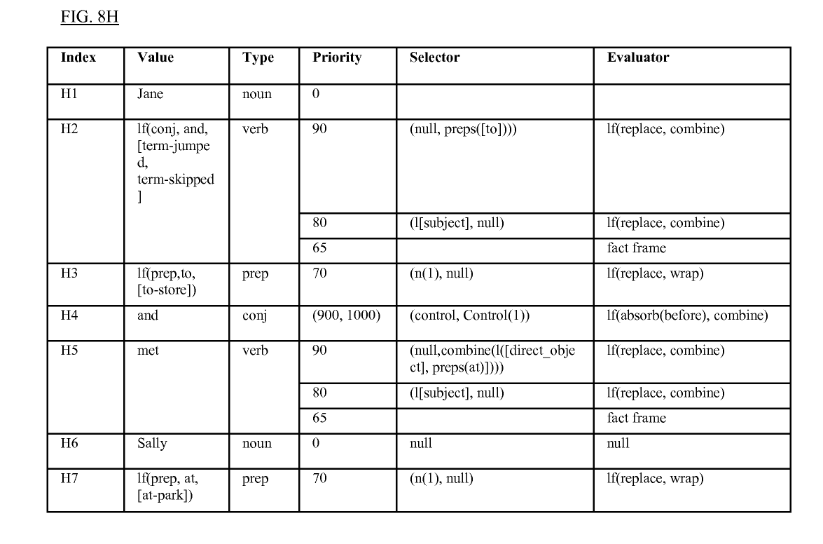

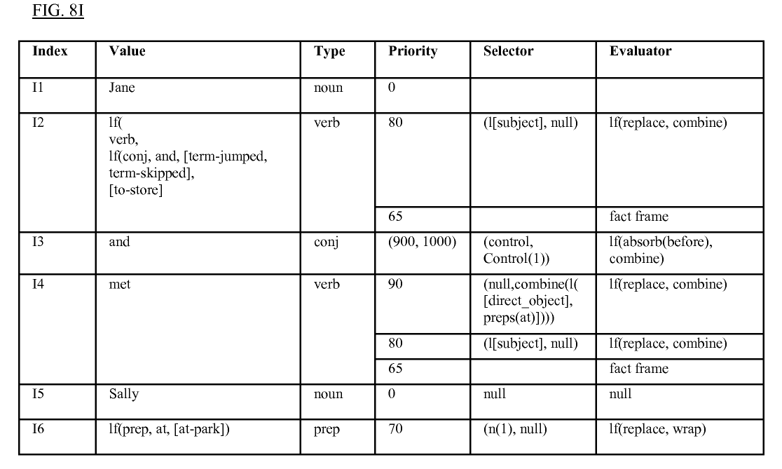

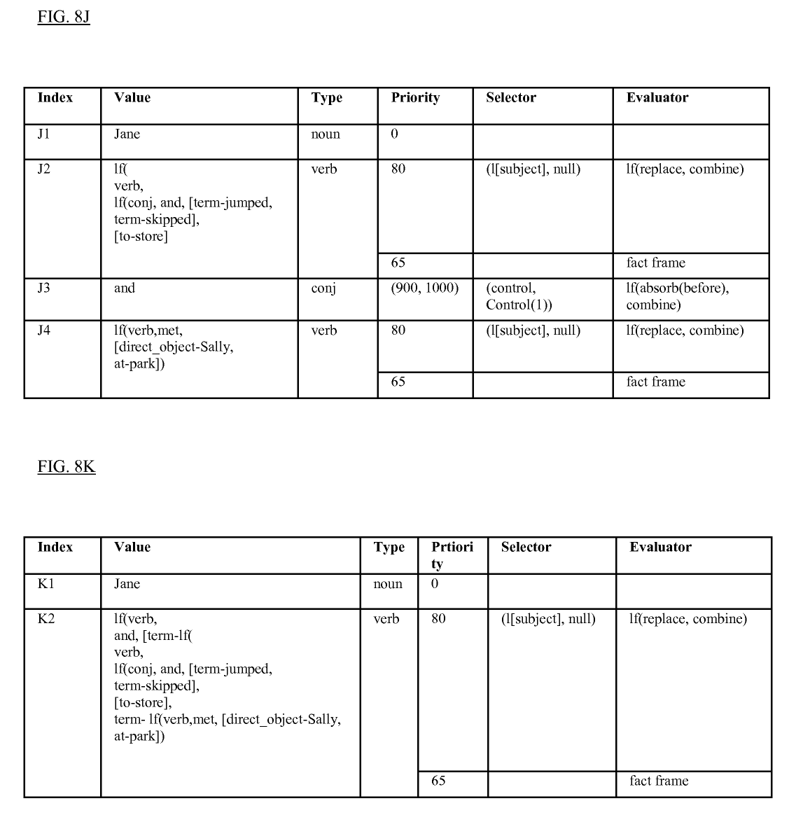

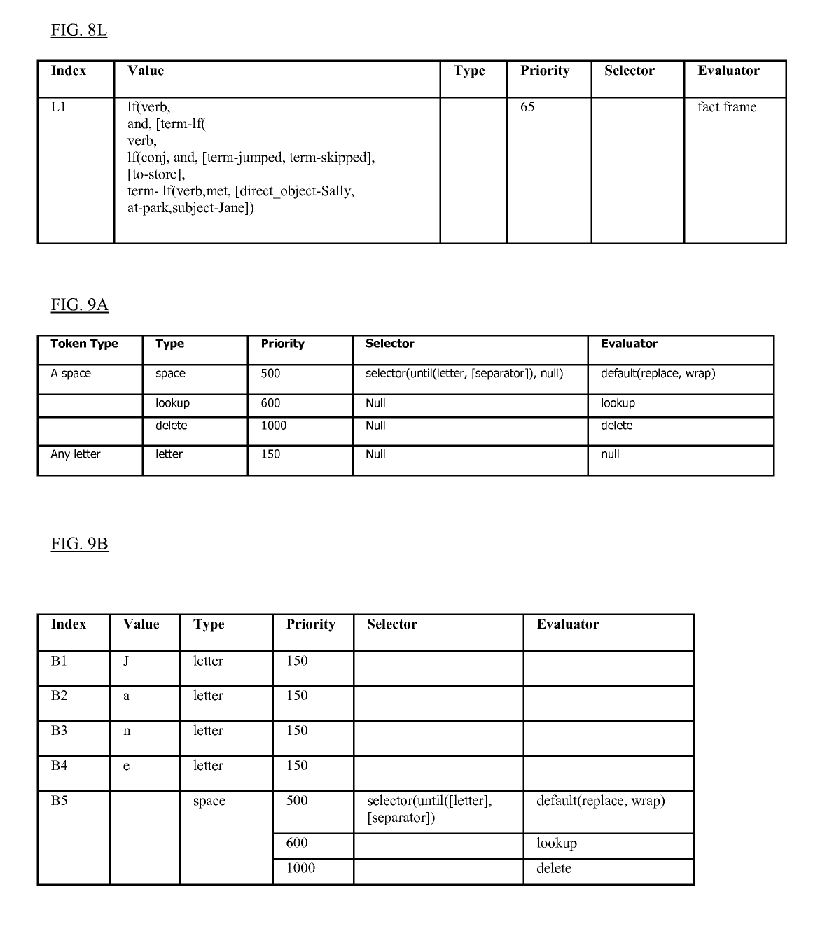

What follows is a worked example of the enhanced operator precedence parser. Assume the lexicon in show in the table in FIG. 8A and the input shown in the table in FIG. 8B. After performing step one the matrix of elements, Es, is as shown in FIG. 8C.

The first iteration of the loop produces the matrix shown in FIG. 8D. The steps are as follows.

2. The list O is set to empty

3. The element with highest priority is number C3.
C. The selection expression selects elements C2 and C4. They have matching control values.
E. The default evaluators is applied to the arguments yielding, lf(conj, [jumped, skipped]), known as R.
F. Elements C2 to C4 are replaced by R at position D2. The control of R is obtained from the verbs combined as indicated by the absorb(before).

The second iteration of the loop produces the matrix shown in FIG. 8E. The steps are as follows.

2. The list O is set to empty.

3. Find the element in Es with the highest operator priority not in O. This is element D6.
B. Add the element E to the set O. Set O now contains element D6.
C. Use the selection expression to select the elements from the matrix. The selection fails since element D5 and element D7 do not having matching control.
D. Retry step three.

3. Find the element in Es with the highest operator priority not in O. This is called element D4.
B. Add the element E to the set O.O contains element D4 and element D6.
C. Element D5 is selected as an argument.
E. The result of applying element D4 to element D5 has a control that is the same as element D5. This is denoted by the absorb(after) term. The result value is the value of the element E4. This is denoted by the select(1) term that selected the Nth Argument. Note that the value can be more sophisticated and contain information about the determiner. For simplification this is not shown.

The third iteration of the loop produces the matrix shown in FIG. 8F. The steps are as follows.

2. The list O is set to empty.

3. Find the element in Es with the highest operator priority not in O. This is element E5.
B. Add the element E to the set O. Set O now contains element E5.
C. Use the selection expression to select the elements from the matrix. The selection fails since element E4 and element E6 do not having matching control.
D. Retry step three.

3. Find the element in Es with the highest operator priority not in O. This is called element E9.
B. Add the element E to the set O.O contains element E9 and element E5.
C. Element E10 is selected as an argument.

E. The result of applying element E9 to element E10 has a control that is the same as element E10. This is denoted by the absorb(after) term. The value is the value of the element E10. This is denoted by the select(1) term that selected the Nth Argument. Note that the value can be more sophisticated and contain information about the determiner. For simplification this is not shown. The result value is at position F9.

The forth iteration of the loop produces the matrix shown in FIG. 8G. The steps are as follows.

2. The list O is set to empty.

3. Find the element in Es with the highest operator priority not in O. This is element F5.
B. Add the element E to the set O. Set O now contains element F5.
C. Use the selection expression to select the elements from the matrix. The selection fails since element F4 and element F6 do not having matching control.
D. Retry step three.

3. Find the element in Es with the highest operator priority not in O. This is called element F3.
B. Add the element E to the set O.O contains element F3 and element F5.
C. Element F4 is selected as an argument.
E. The result of applying element F3 to element F4 has a control the remaining control elements from element F3. The value is the a new linguistic frame at position G3. These are specified by the evaluator.

The fifth iteration of the loop produces the matrix shown in FIG. 8H. The steps are as follows.

2. The list O is set to empty.

3. Find the element in Es with the highest operator priority not in O. This is element G4.
B. Add the element E to the set O. Set O now contains element G4.
C. Use the selection expression to select the elements from the matrix. The selection fails since element G3 and element G5 do not having matching control.
D. Retry step three.

3. Find the element in Es with the highest operator priority not in O. This is called element G7.
B. Add the element E to the set O.O contains element G4 and element G7.
C. Element G8 is selected as an argument.
E. The result of applying element G7 to element G8 has a control the remaining control elements from element G7. The value is the a new linguistic frame at position H7. These are specified by the evaluator.

The sixth iteration of the loop produces the matrix shown in FIG. 81. The steps are as follows.

2. The list O is set to empty.

3. Find the element in Es with the highest operator priority not in O. This is element H4.
B. Add the element E to the set O. Set O now contains element H4.
C. Use the selection expression to select the elements from the matrix. The selection fails since element H3 and element H5 do not having matching control.
D. Retry step three.

3. Find the element in Es with the highest operator priority not in O. This is called element H2.
B. Add the element E to the set O.O contains element H2 and element H4.
C. Element H3 is selected as an argument.
E. The result of applying element H2 to element H3 has a control the remaining control elements from element H2. The value is the a new linguistic frame at positon I2. These are specified by the evaluator. Notice that element H3 could have been applied as an operator to a preceding noun phrase but in the context the verb phrase used it first.

The eighth iteration of the loop produces the matrix shown in FIG. 8J. The steps are as follows.

2. The list O is set to empty.

3. Find the element in Es with the highest operator priority not in O. This is element I3.
B. Add the element E to the set O. Set O now contains element I3.
C. Use the selection expression to select the elements from the matrix. The selection fails since element I2 and element I4 do not having matching control.
D. Retry step three.

3. Find the element in Es with the highest operator priority not in O. This is called element I4.
B. Add the element E to the set O.O contains element I3 and element I4.
C. Element I5 and I6 are selected as an argument.
E. The result of applying element I4 to element I5 and I6 has a control the remaining control elements from element I4. The value is the a new linguistic frame at position J4. These are specified by the evaluator.

The ninth iteration of the loop produces the matrix shown in FIG. 8K. The steps are as follows.

2. The list O is set to empty.

3. Find the element in Es with the highest operator priority not in O. This is called element J3.
B. Add the element E to the set O.O contains element J3.
C. Element J2 and J4 are selected as an argument since the controls match. An enhancement would be to define a manner of combining or intersecting control when perfect matches are not possible.
E. The result of applying element J3 to element J2 and J4 has a control the remaining control elements that are common to elements J2 and J4. The value is the a new linguistic frame at position K2. These are specified by the evaluator.

The tenth iteration of the loop produces the matrix shown in FIG. 8L. The steps are as follows.

2. The list O is set to empty.

3. Find the element in Es with the highest operator priority not in O. This is called element K2.
B. Add the element E to the set O.O contains element K2.
C. Element K1 is selected as an argument
E. The result of applying element K2 to element K1 has a control the remaining control elements from element K2. The value is the a new linguistic frame at position L1. In this case, the subject term is added to the cases already present in the linguistic frame. These are specified by the evaluator.

Further processing is not shown. The fact frame evaluator can be used to map the linguistic structures into data structures that allow for further processing that could for example perform an action or record a fact.

### Tokenization Example

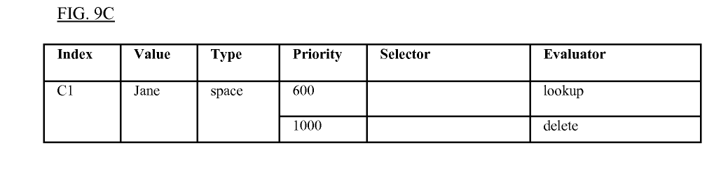

What follows is an example of using the enhanced operator precedence parser to tokenize an input. The parser can be used to tokenize as well as to perform higher level analysis as in the previous example at the same time. The lexicon for the tokenization example is shown in FIG. 9A.

For the following input, step one is applied where each character is a token

“Jane jumped”

After applying Step 1 of the method the matrix of elements looks like the table shown in FIG. 9B.

For the first pass the highest priority operator is element B5. The selector select elements B1 to B4. The default evaluate uses wrap to group the arguments in a list as the new value. The control for the new value is to replace. The result of the first iteration is shown in FIG. 9C.

The processing then continues with a lookup in the dictionary. These definitions can be combined with previous example to produce a system that can process input from a bare utterance. What comprises tokenization and parsing in typical models is integrated into a single model.

### Definitions for Common English Categories

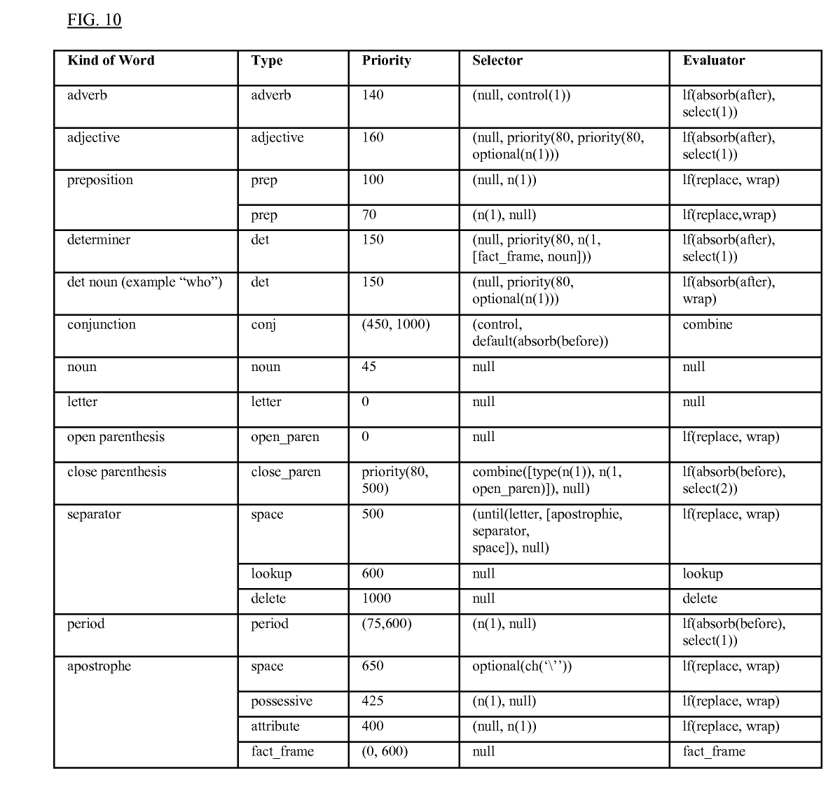

FIG. 10 shows a table that contains definitions for common categories of English words. This can be extended to types of words present in other languages as well.

### Enhancements

A working version of the algorithm would include a more sophisticated control structure. The control structure would allow for alternative using a backtracking algorithm similar to Prolog. To simplify the presentation this is not shown. As well, the algorithms for backtracking are well known and easily applied.

For each element, properties could be maintained to further characterize the element. These properties could be used in the selection process as well as to maintain semantics. When using the enhanced operator precedence model for analysis, structures from languages other than English are represented with interoperable definitions. This allows utterances that contains mixed languages to be seamlessly processed. Other layers of definitions could be added to support converting sounds into elements that are then tokenized and further processed. This would provide a seamless model for processing speech into action.

I claim:

1. A computerized method for tokenizing plain text utterances, creating syntactic structures and building semantic interpretations.

2. The method of claim one wherein there is a single control matrix for developing a complete analysis of the entire utterance.

3. The method of claim one wherein there is a priority marking system for determining operator application ordering.

4. The method of claim one wherein there is a system for selecting arguments for operators during application.

5. The method of claim one wherein there is a system for defining semantics of a given operator.

6. The method of claim one wherein there is a method of handling multi-sentence input including incomplete utterances.

7. A method of applying an enhanced operator precedence parser to natural language expressions further comprising the expression of common natural language syntactic categories using lower level operator definitions.

8. The method of claim seven, further comprising a method of tokenizing utterance fully integrated with the parsing action.

9. The method of claim seven further comprising a method of applying an enhanced operator precedence parser to multilingual utterances in an integrated manner.
